(19) United States
(12) Patent Application Publication
(10) Pub. No.: US 2004/0141749 A1
(43) Pub. Date: Jul. 22, 2004

(54) Optical receiver and optical add/drop apparatus

(76) Inventors: Tomohiro Otani, Kamifukuoka-shi (JP); Tetsuya Miyazaki, Kamifukuoka-shi (JP); Shu Yamamoto, Kamifukuoka-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/748,409

(22) Filed: Dec. 29, 2003

Related U.S. Application Data
(62) Division of application No. 09/607,186, filed on Jun. 29, 2000.

(30) Foreign Application Priority Data
Jul. 2, 1999 (JP) 11(1999)-189715

(51) Int. Cl. H04J 14/02

(52) U.S. Cl. 398/83

(57) ABSTRACT

Signal light (at a wavelength λs), entered an input terminal from an optical transmission line, inputs a combiner through an optical amplifier. The combiner combines the output light of the optical amplifier and the probe light (at a wavelength λp) from a probe light source and applies them to an EA modulator. The EA modulator superimposes a waveform of the signal light on the probe light. An optical BPF transmits only the component of the probe wavelength λp in the output light of the EA modulator. A photodetector converts the output light of the optical BPF into an electric signal, and an amplifier electrically amplifies the output of the photodetector. A BPF extracts the clock component of the input signal light from the output of the amplifier and applies it to a driver. The driver pulsatively drives the probe light source at the same frequency with that of the clock signal from the BPF and adjusts its pulse phase so as to synchronize with the current pulse from the EA modulator. A laser light source generates a probe light pulse according to a driving signal from the driver.

### CROSS-REFERENCE TO RELATED APPLICATION(S)

This application is a divisional of application Ser. No. 09/607,186, filed Jun. 29, 2000, which claims priority of Japan Application No. 11 (1999) 189715, filed Jul. 2, 1999.

### FIELD OF THE INVENTION

This invention relates to an optical receiver and an optical add/drop apparatus.

### BACKGROUND OF THE INVENTION

In a wavelength multiplexing optical transmission system, a waveform of an optical pulse deteriorates due to chromatic dispersion and nonlinear effect in an optical transmission line. This deterioration of the waveform becomes intersymbol interference causing degradation of transmission characteristics. Owing to the influence of the nonlinear effect, compensation of the accumulated chromatic dispersion alone is not sufficient to prevent such condition.

Also, on account of dispersion slope of an optical fiber, the chromatic dispersion differs per wavelength channel and thus each accumulated chromatic dispersion value also differs accordingly. In a conventional reception terminal, a dispersion compensating fiber having a dispersion compensation value corresponding to an accumulated chromatic dispersion of each wavelength channel is disposed for each wavelength channel, and received light is demultiplexed into each wavelength, transmitted in the corresponding dispersion compensating fiber for each wavelength channel in which the accumulated chromatic dispersion of each wavelength is compensated, and then converted into an electric signal.

For a wavelength with accumulated minus dispersion, for instance, a fiber having a plus dispersion value is used as the dispersion compensating fiber. When the absolute value of the accumulated chromatic dispersion becomes larger as the transmission distance becomes longer, the length of the dispersion compensating fiber itself becomes a matter of serious concern. Supposing a 9000-km optical fiber transmission system, the dispersion slope of a standard dispersion shift fiber is approximately 0.1 ps/nm²/km and thus the accumulated chromatic dispersion of a signal of shorter wavelength by 5 nm from the zero dispersion wavelength becomes approximately −4500 ps/nm after 9000-km transmission. When this accumulated chromatic dispersion is to be compensated using a single mode fiber (generally, its chromatic dispersion is 20 ps/nm/km), the length of the fiber should be 200 km or more.

In a wavelength division multiplexing optical transmission system, it is required to provide such long dispersion compensating fibers of the same number with the wavelength channels. This becomes one of the causes to enlarge the size of the reception terminal equipment.

Although it is necessary to optimize the dispersion compensation value per wavelength channel, characteristics of a transmission line is uncertain until it is actually installed and this makes it difficult to design an optimum terminal station. Accordingly, the terminal stations are generally designed to allow for a certain amount of margin.

Also, a reception bandwidth of a receiver for each wavelength channel is uneven. An optimum reception waveform also differs owing to the unevenness of the reception bandwidth, and thus such function is required to unify the waveforms of the optical signals before receiving them, in order to optimize the reception characteristics of the respective wavelength channels and homogenize or equalize the reception characteristics among the wavelength channels.

Furthermore, when a fault occurs, the optical transmission line is switched to another. Generally, the deterioration of the waveform of the optical signal changes according to the replacement, and hence such means is required to adaptively compensate the wavelength deterioration. However, no simple means to meet such demand has been provided yet.

### SUMMARY OF THE INVENTION

An object of the present invention is to provide an optical receiver and an optical add/drop apparatus for obtaining a similar effect to the compensation of the chromatic dispersion without any chromatic dispersion compensating element.

Another object of the present invention is to provide an optical receiver and an optical add/drop apparatus for flexibly adjusting to a variation of the transmission characteristics and a switchover of the transmission lines.

An optical receiver according to the invention comprises a waveform equalizer for equalizing a waveform of a signal to carry information and a photodetector for converting an output signal of the waveform equalizer into an electric signal. The waveform equalizer equalizes the waveform of the signal light deteriorated on an optical transmission line and applies it to the photodetector. Accordingly, the signal light, which accumulated chromatic dispersion and nonlinear effect are removed, can be obtained without using any accumulated chromatic dispersion compensating element. In this manner, no long dispersion compensating fiber is required and hereby the reception terminal equipment can be miniaturized. The reception characteristics are greatly improved, and it is adaptable to the variation of the transmission characteristics and therefore the switchover of the transmission lines.

The waveform equalizer for example comprises a clock extractor for extracting a clock component of the information, a prove light source for generating probe pulse light having a wavelength different from that of the signal light, a driver for pulse-driving the prove light source according to the clock component, and an information transcriber for transcribing the information carried by the signal light on the prove pulse light.

The clock extractor extracts the clock component of the information from the output of the photodetector. The information transcriber includes an electroabsorption type optical modulator, and the driver adjusts a phase of the prove pulse light generated by the probe light source according to an electrode current of the electroabsorption type optical modulator. Accordingly, obtained is the probe pulse light to synchronize with the pulse of the input signal light, and hence the signal waveform can be transcribed on it as a satisfactory waveform regardless of the waveform deterioration of the input signal light.

An optical add/drop apparatus according to the invention consists of an input terminal connecting with a first optical transmission line, an output terminal connecting with a second optical transmission line, a drop light output terminal, an add light input terminal, a wavelength equalizer for equalizing a waveform of incident light, a first optical coupler for applying input light of the input terminal to one of the drop light output terminal and the waveform equalizer, and a second optical coupler for applying one of light from the add light input terminal and output light from the waveform equalizer to the output terminal.

With this configuration, the signal waveform can be easily reshaped at a cross-connect node or the like on an optical network and thus transmission characteristics are improved.

The first optical coupler includes for instance an optical switch for selectively applying the input light of the input terminal to one of the drop light output terminal and the waveform equalizer. The second optical coupler includes for example an optical switch for selectively applying one of the light from the add light input terminal and the output light from the waveform equalizer to the output terminal.

### BRIEF DESCRIPTION OF THE DRAWING

The above and other objects, features and advantages of the present invention will be apparent from the following detailed description of the preferred embodiments of the invention in conjunction with the accompanying drawings, in which:

FIG. 1 shows a schematic block diagram of a first embodiment according to the invention;

FIG. 2 shows a schematic block diagram of an embodiment applied to a WDM optical receiver;

FIG. 3 shows a schematic block diagram of a configuration for an optical cross-connect node; and

FIG. 4 illustrates a schematic block diagram showing a configuration of an optical cross-connect node on an optical network.

### DESCRIPTION OF THE PREFERRED EMBODIMENT

Embodiments of the invention are explained below in detail with reference to the drawings.

It is known that a waveform of signal light is transcribed on prove light when the signal light and the prove light (CW) enter a reverse biased EA modulator in such condition that the intensity of the signal light reaches the degree to saturate the loss of the EA modulator or over (cf. Japanese Patent open disclosure Gazette No. 10-78595 (U.S. Pat. No. 5,959,764) and Edagawa et al., “Novel Wavelength converter using an electroabsorption modulator: conversion experiments at up 40 Gbit/s”, OFC '97 Technical Digest, Tuesday Afternoon, pp. 77-78).

When regenerated clock pulse light is used as the probe light instead of the CW light, the clock pulse is modulated by the signal light according to the similar principle. In this manner, the signal carried by the deteriorated optical pulse due to the accumulated dispersion can be converted into a neat optical pulse train.

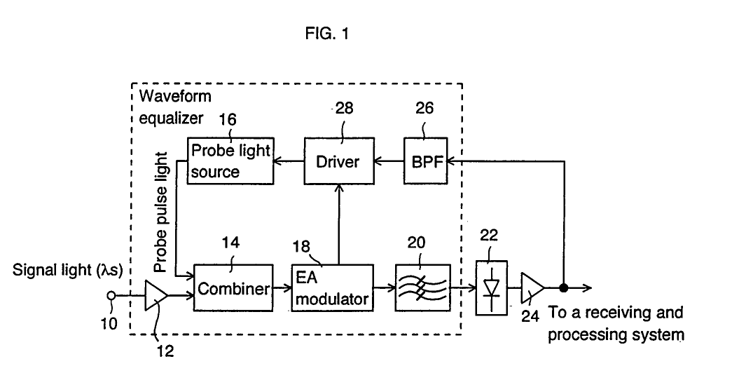

FIG. 1 shows a schematic block diagram of a first embodiment according to the invention. Signal light (at a wavelength λs), which waveform is deteriorated after propagating on an optical transmission line, enters an input terminal i0. An optical amplifier 12 amplifies the signal light from the input terminal 10 to a predetermined level or more and applies it to a combiner 14. The combiner 14 combines the signal light from the optical amplifier 12 and probe light (at a wavelength λp) output from a probe light source 16 and applies them to an EA modulator 18. The probe light output from the probe light source 16 includes clock pulse light having the same frequency with that of the input signal light (at the wavelength λs) of the input terminal 10. Although the details are described later, the probe light from the probe light source 16 is synchronously controlled with the input signal light (at the wavelength λs) of the input terminal 10.

The transmittance of the EA Modulator 18 is saturated because of the signal light with the sufficient optical intensity, and the signal of the signal light is transcribed on the probe light. The concrete operation is described in the aforementioned gazette and paper. An optical bandpass filter (BPF) 20 transmits only the component of the probe wavelength λp out of the output light from the EA modulator 18. That is, the output light of the optical bandpass filter 20 carries the signal, which is carried by the input signal light (at the wavelength λs) of the input terminal 10, at the wavelength λp and waveform of the output light of the probe light source 16.

A photodetector 22 converts the output light of the optical BPF 20 into an electric signal, and an amplifier 24 electrically amplifies the output of the photodetector 22. A bandpass filter 26 extracts the clock component of the input signal light from the output of the amplifier 24 and applies it to a driving circuit 28. The output of the amplifier 24 is also applied to the following receiving and processing circuit as a received data.

Also applied to the driving circuit 28 is a current generated at an electrode of the EA modulator 18. The current generated at the electrode of the EA modulator 18 reflects the time variation (the combination of the time variation of the intensity of the probe light output from the probe light source 16 and that of the input signal light of the input terminal 10) of the intensity of the input light of the EA modulator 18. When the optical intensity of the probe light pulse is controlled to be weaker than that of the input signal light of the input terminal 10, the current generated at the electrode of the EA modulator 18 entirely reflects the time variation of the intensity of the input signal light of the input terminal 10.

The driving circuit 28 pulsatively drives the probe light source 16 at the same frequency with that of the clock signal from the BPF 26 and adjusts its pulse phase to synchronize with the current pulse from the EA modulator 18. The probe light source 16 generates the probe light pulse of the wavelength λp according to the driving signal from the driving circuit 28. Needless to say, the probe light source 16 can be either to have a configuration in which a laser diode is directly driven and modulated by the driving current from the driving circuit 28 or a configuration consisting a laser diode to laser-oscillate continuously at the wavelength λp and a modulator to pulse-modulate the output CW light from the laser diode according to the driving current from the driving circuit 28.

In the embodiment shown in FIG. 1, the waveform equalizer consists of the optical amplifier 12, the combiner 14, the probe light source 16, the EA modulator 18, the optical BPF 20, the BPF 26, and the driving circuit 28.

In this embodiment, a means for feedback-controlling the phase of the probe light pulse is disposed and thereby the signal of the input signal light can be stably transcribed or converted on a neat pulse waveform. As a result, the signal light with no waveform deterioration enters the photodetector 22 regardless of the accumulated chromatic dispersion value on the optical transmission line. This also means that the waveform (including the pulse width and peak intensity) of the optical pulse to enter the photodetector 22 can be determined unrelated to the transmission characteristics of the optical transmission line, namely the waveform of the input signal light of the input terminal 10. The optimization of photoelectric conversion characteristics at the photodetector is therefore extremely easy and also it is flexibly and easily adjusted to the variation of the transmission characteristics on the optical transmission line and the switchovers of the optical transmission lines.

The probe light includes the pulse light having the same frequency with that of the signal clock of the signal light from the optical transmission line and therefore it is possible to suppress the intersymbol interference, which can not be compensated through the dispersion equalization.

In the foregoing embodiment, the signal light and probe light propagated in the same direction in the EA modulator 18. However, it is obvious that, as described in the above-mentioned gazette and paper, the signal light and the probe light can propagate in the mutually opposite directions in the EA modulator using an optical circulator.

In the embodiment shown in FIG. 1, the signal clock is extracted from the light after the waveform equalization. However, it is also applicable to extract the signal clock from the input signal light of the input terminal 10 and applies it to the driving circuit 28.

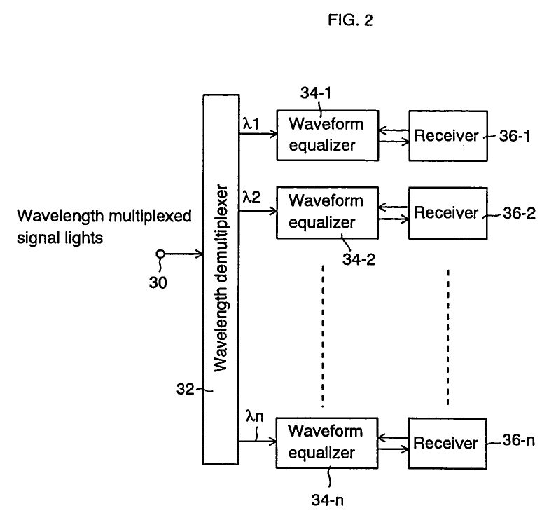

FIG. 2 shows a schematic block diagram of an embodiment of a receiver for wavelength division multiplexed signal lights. The wavelength division multiplexed signal lights, in which signal lights of n wavelengths from λ1 to λn are wavelength-division-multiplexed, enter an input terminal 30. A wavelength demultiplexer 32 demultiplexes the wavelength division multiplexed signal lights from the input terminal 30 into the respective wavelengths λ1˜λn. The wavelength demultiplexer 32 consists for instance of an arrayed waveguide grating, a fiber grating or a multilayer filter or the like. Waveform equalizers 34-1˜34-n respectively equalize waveforms of the optical signals of wavelengths λ1˜λn from the wavelength demultiplexer 32. The configuration of the waveform equalizers 34-1˜34-n is the same with that of the waveform equalizer shown in FIG. 1. The optical signals which waveforms are equalized at the respective waveform equalizers 34-1˜34-n enter receivers 36-1˜36-n to be converted into electric signals and get a receiving procedure respectively. The respective receivers 36-1˜36-n also extract the clock component of the received data and apply it to the corresponding waveform equalizers 34-1˜34-n.

In this manner, it becomes unnecessary to provide the long dispersion compensating fiber for each wavelength channel and the influence of the nonlinear effect can be removed as well. The reception terminal equipment is miniaturized as well as the reception characteristics are easily optimized. The waveform equalizers 34-1˜34-n function as wavelength converters for unifying the wavelengths of the input light of the receivers 36-1˜36-n or reducing the number of the wavelengths compared to that of the wavelength channels.

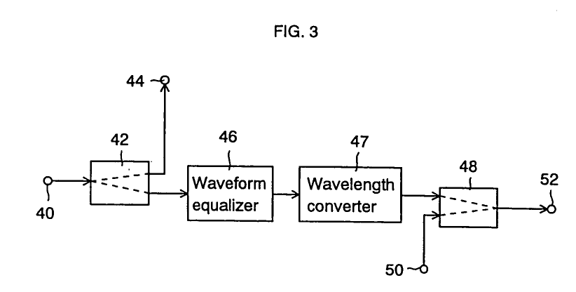

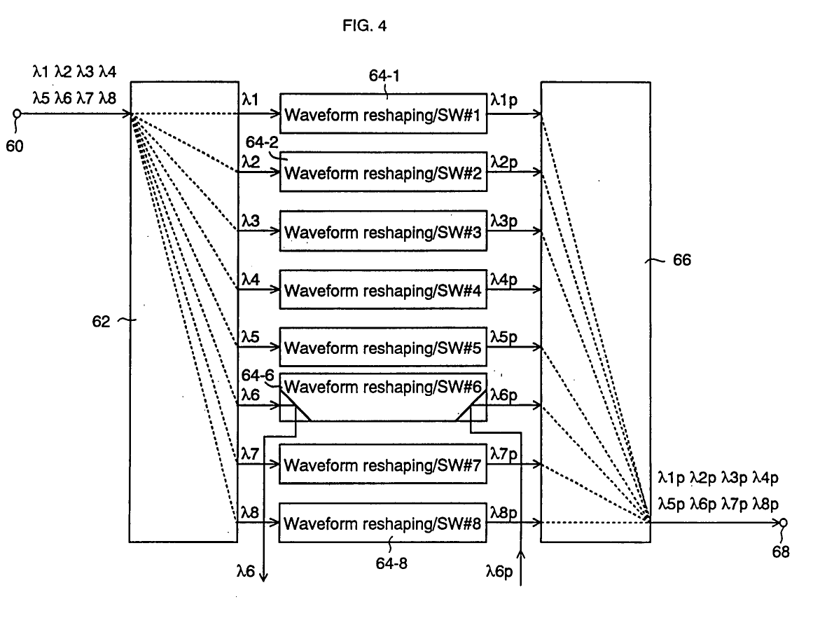

The waveform equalizer can be applied not only to the reception terminal but also to an optical cross-connect node in an optical network. An example of this configuration is shown in FIG. 3, and FIG. 4 illustrates an embodiment in which such configuration is disposed in a network.

FIG. 3 is explained below. Signal light enters an optical switch 42 from an input terminal 40. The optical switch 42 applies the signal light from the input terminal 40 to a drop light terminal 44 or a waveform equalizer 46. The waveform equalizer 46 includes the similar configuration to that of the waveform equalizer shown in FIG. 1 and hence equalizes a waveform of the input signal light in the similar operation. In addition to the configuration of the waveform equalizer shown in FIG. 1, the waveform equalizer 46 should further includes an optical divider for dividing the output light of the optical bandpass filter 20 and a photodetector for converting one output of the optical divider into an electric signal and applying it to the bandpass filter 26.

A wavelength converter 47 converts the wavelength of the output light of the waveform equalizer 46 into the same wavelength with that of the input signal light of the input terminal 40. The wavelength converter 47 includes for instance the same configuration with that disclosed in the aforementioned gazette. When it is unnecessary to equalize the wavelength of the output light of the waveform equalizer to that of the input signal light of the input terminal 40, the wavelength converter 47 can be omitted. An optical switch 48 selects either the output light of the wavelength converter 47 or light from an add light terminal 50 and outputs it toward an output terminal 52.

Depending on its purpose or function, a 3-dB coupler may be disposed instead of the optical switch 42, 48. It is also applicable that the wavelength converter 47 is disposed before the waveform equalizer 46 so that waveform is equalized after wavelength conversion.

FIG. 4 is explained below. Wavelength division multiplexed signal lights, in which 8 signal lights of wavelengths λ1˜λ8 are wavelength-division-multiplexed, enter an input terminal 60. A wavelength demultiplexer 62, that is an arrayed waveguide grating, demultiplexes the signal lights from the input terminal 60 into the respective wavelengths λ1˜λ8 and applies the signal lights at the respective wavelengths λ1˜λ8 to waveform reshaping/optical switching circuits 64-1˜64-8 having the configuration shown in FIG. 3. The output optical signals of the waveform reshaping/optical switching circuits 64-1˜64-8 enter a wavelength multiplexer 66. The wavelength multiplexer 66 multiplexes the output lights of the waveform reshaping/optical switching circuits 64-1˜64-8 and outputs the multiplexed lights toward another optical transmission line through an output terminal 68.

The waveform reshaping/optical switching circuits 64-1˜64-8 use the optical switch 42 to select either to drop the light from the wavelength demultiplexer 62 or to equalize the waveform of the light using the waveform equalizer 46, and uses the optical switch 48 to select which light in the output light from the waveform equalizer 46 and the light from the add light terminal 50 should be applied to the wavelength multiplexer 66.

The wavelength equalizer 46 also includes a wavelength conversion function for converting a wavelength λi of the incident light into a different wavelength. The waveform equalizer 46 in the waveform reshaping/optical switching circuits 64-i (i=i˜8) convert the wavelength λi of the input light into a wavelength different to the wavelength λi, and the wavelength converter 47 converts the wavelength of the output light of the waveform equalizer 46 into the wavelength λip. As shown in FIG. 4, when the optical switch 42 in the waveform reshaping/optical switching circuits 64-6 is connected to the drop side while the optical switch 48 is connected to the add side, it becomes possible that the signal light of the wavelength λ6 is picked up from the optical network as well as a signal light of the wavelength λ6p is introduced to the optical network.

It is depends on a specification or a demand in each optical network to equalize the input light wavelength λi and the output light wavelength λip of the waveform reshaping/optical switching circuits 64-i (i=1˜8). When it is unnecessary to equalize these wavelengths, the wavelength converter 47 can be omitted as explained above.

As readily understandable from the foregoing, according to the invention, the reception characteristics can be extremely improved, and the reception terminal equipment is drastically simplified as well as miniaturized. The design itself of the reception terminal is also simplified and the reception characteristics are homogenized.

While the invention has been described with reference to the specific embodiment, it will be apparent to those skilled in the art that various changes and modifications can be made to the specific embodiment without departing from the spirit and scope of the invention as defined in the claims.

What is claimed is:

1. An optical add/drop apparatus comprising:
an input terminal connecting with a first optical transmission line;
an output terminal connecting with a second optical transmission line;
a drop light output terminal;
an add light input terminal;
a waveform equalizer for equalizing a waveform of input light;
a first optical coupler for applying the input light of the input terminal to one of the drop light output terminal and the waveform equalizer; and
a second optical coupler for applying one of light from the add light input terminal and the output light of the waveform equalizer to the output terminal.

2. The optical add/drop apparatus of claim 1 wherein the first optical coupler comprises an optical switch for selectively applying the input light of the input terminal to one of the drop light output terminal and the waveform equalizer.

3. The optical add/drop apparatus of claim 1 wherein the second optical coupler comprises an optical switch for selectively applying one of the light from the add light input terminal and the output light of the waveform equalizer to the output terminal.

4. The optical add/drop apparatus of claim 1 wherein the waveform equalizer comprises a wavelength converter and the wavelengths of the input light and the output light of the waveform equalizer are identical.
